(19) United States
(12) Patent Application Publication
(10) Pub. No.: US 2022/0105513 A1
(43) Pub. Date: Apr. 7, 2022

(54) CONFIGURABLE POINT-OF-CARE DIAGNOSTIC ASSAY TESTING SYSTEM

(71) Applicant: Triv Tech DX, LLC, Farmers Branch, TX (US)

(72) Inventors: Krutarth Trivedi, Plano, TX (US); Vikas Rao, Frisco, TX (US); Espir Kahatt, Carlsbad, CA (US); Kyle Elsabee, San Diego, CA (US); Kyle Bulloch, Rancho Santa Fe, CA (US)

(21) Appl. No.: 17/088,289

(22) Filed: Nov. 3, 2020

Related U.S. Application Data
(60) Provisional application No. 63/086,239, filed on Oct. 1, 2020.

(51) Int. Cl. B01L 3/00

(52) U.S. Cl. CPC B01L 3/502761; B01L 3/502738; B01L 2300/027; B01L 2300/042; B01L 2400/0644; B01L 2200/0668

(57) ABSTRACT

An assay cartridge and an assay reader or other system for running an assay on the assay cartridge. The assay cartridge can be configured to perform different types of diagnostic assays, and the assay reader can be configured to run the specific assay for which the assay cartridge is configured, including PCR assays, immunoassays, and electrochemical bioassays. The assay cartridge can be inserted into the assay reader to run an assay. In some embodiments, the assay reader may have a user interface for configuring the assay reader and displaying results. In other embodiments, a phone or other device with a user interface and a diagnostic assay protocol application can communicate with the assay reader to provide the appropriate protocol instructions to run the assay, to collect and analyze data from the assay reader, and to report and store assay results.

### TECHNICAL FIELD

The present invention relates generally to a system and method for performing diagnostic assays, and, in particular embodiments, to a portable, reconfigurable system and method that enables personnel to perform multiple types of diagnostic tests with minimal training.

### BACKGROUND

In general, diagnostic tests such as medical tests, tests for bacterial contamination, tests for counterfeit fish and meats, and tests for environmental pollutants are conducted in testing laboratories by highly trained personnel using expensive diagnostic testing equipment that can be difficult to move. Each piece of equipment is designed to perform a particular type of diagnostic assay. Often it takes many days to collect samples, transport them to the laboratory, and run the tests before testing results are available so appropriate actions may be taken.

Depending upon the disease, pollutant, or contaminant, different diagnostic tests are required. Antibody and antigen testing can be used to identify what type of bacteria is making a patient ill, contaminating food, or to measure hormone levels to determine if a patient is pregnant. Polymerase chain reaction (PCR) testing can be used to detect very low levels of virus or bacterial infection and to determine if the infecting bacteria is a drug resistant strain so the correct medication can be prescribed.

Sometimes it is sufficient for a diagnostic test to determine if a pathogen or contaminant is present. Other times the exact concentration of the pathogen or contaminant must be determined. Tests that provide only positive or negative indications are typically much cheaper to run than exact concentration tests. Depending upon the need, different diagnostic tests with different price tags can be performed. These tests may include PCR, isothermal PCR, enzyme immunoassay, lateral-flow assays, and electrochemical bioassays, among others.

While the benefits of certain diagnostic testing may be widely accepted, improvements to systems and processes can continue to make such testing more accessible, versatile, and economical.

### SUMMARY

New and useful systems, apparatuses, and methods for point-of-care diagnostic assay testing are set forth in the appended claims. Illustrative embodiments are also provided to enable a person skilled in the art to make and use the claimed subject matter.

For example, some embodiments may comprise an assay cartridge and an assay reader or other system for running an assay on the assay cartridge. The assay cartridge can be configured to perform different types of diagnostic assays, and the assay reader can be configured to run the specific assay for which the assay cartridge is configured. For example, in some embodiments, the assay cartridge and the assay reader can be configured to run PCR assays, immunoassays, and electrochemical bioassays. The assay cartridge can be inserted into the assay reader to run an assay. In some embodiments, the assay reader may have a user interface for configuring the assay reader and displaying results. In other embodiments, a phone or other device with a user interface and a diagnostic assay protocol application can communicate with the assay reader to provide the appropriate protocol instructions to run the assay, to collect and analyze data from the assay reader, and to report and store assay results.

More generally, some embodiments of a cartridge for use in a diagnostic testing system may comprise a pneumatic port, a sample collection chamber, a mixing chamber fluidly coupled to the pneumatic port, a plurality of reagent chambers, and a plurality of reaction-chamber ports. Each of the reaction-chamber ports may be configured to receive a reaction chamber for a specific assay. A valve may be fluidly coupled to the mixing chamber and operable to selectively couple the mixing chamber to the sample collection chamber, one of the reagent chambers, and one of the reaction-chamber ports. In more specific embodiments, the cartridge may further comprise a capture chamber fluidly coupled to the mixing chamber and configured to capture magnetic micro-beads. In some embodiments, the cartridge may further comprise a waste chamber, and the valve may be operable to selectively couple the mixing chamber to the waste chamber. The valve may be operable to selectively couple the mixing chamber to the sample collection chamber, one of the reagent chambers, and one of the reaction-chamber ports through one or more microchannels.

In yet other, more specific embodiments, the cartridge may further comprise a valve housing, a valve microchannel disposed in the valve, a cap configured to hold the valve in the valve housing, and a cap microchannel in the cap. The cap microchannel can be fluidly coupled to the valve microchannel.

In some embodiments, the cartridge may additionally comprise one or more of a valve interface configured to be coupled to an assay reader configured to run a diagnostic assay, and at least one reaction chamber configured for a specific assay.

Some embodiments of a system for running a diagnostic assay on an assay cartridge may comprise a slot configured to receive the assay cartridge, a detector disk configured to receive one or more detectors for the diagnostic assay, a first motor coupled to the detector disk, a second motor configured to be coupled to a valve interface associated with the assay cartridge; a pneumatic pump configured to be coupled to a pneumatic port associated with the assay cartridge; and a controller. The controller may be configured to operate the pneumatic pump to apply a negative or positive pressure to the pneumatic port, operate the first motor to rotate the detector disk and position the detectors for the diagnostic assay, operate the second motor to operate the valve interface for the diagnostic assay, and analyze assay data from the detectors.

In more specific embodiments, the system may further comprise a communication interface configured to receive an assay protocol and configured to send assay data. The communication interface may be a wireless communication interface in some embodiments.

Some embodiments may additionally comprise a heater module, which may comprise a thermal detector and a light-emitting diode (LED). The thermal detector may be coupled to the controller and configured to measure a temperature of a solution in a reaction chamber in the assay cartridge. The LED may also be coupled to the controller and configured to project thermal radiation onto the reaction chamber in the assay cartridge. The controller can be configured to control the temperature of the solution based on the temperature measured by the thermal detector.

Features, elements, and aspects described in the context of some embodiments may also be omitted, combined, or replaced by alternative features. Other features, objectives, advantages, and a preferred mode of making and using the claimed subject matter are described in greater detail below with reference to the accompanying drawings of illustrative embodiments.

### BRIEF DESCRIPTION OF THE DRAWINGS

For a more complete understanding of the claimed subject matter, and the advantages thereof, reference is now made to the following descriptions taken in conjunction with the accompanying drawings, in which:

FIG. 1 is a block diagram of the components of an example system for providing configurable, multi-assay diagnostic testing;

FIG. 2 is a front view of a reconfigurable assay cartridge that may be associated with some embodiments of the system of FIG. 1;

FIG. 3 is an assembly view of a reconfigurable assay module that may be associated with some embodiments of the cartridge of FIG. 2;

FIG. 4 is a rear view of a cartridge base in the module of FIG. 3;

FIG. 5 is a front view of the cartridge base of FIG. 4;

FIG. 6 is a side view of the cartridge base of FIG. 4;

FIG. 7 is a detail rear view of the valve housing of FIG. 4;

FIG. 8 is a detail front view of the valve housing of FIG. 4;

FIG. 9 is an isometric view of a valve that may be associated with some examples of the cartridge base of FIG. 4;

FIG. 10 is a top view of the valve of FIG. 9;

FIG. 11 is a bottom view of the valve of FIG. 9;

FIG. 12 is an isometric view of a valve cap that may be associated with the valve of FIG. 9;

FIG. 13 is a section view of the valve cap of FIG. 12;

FIG. 14 is a top view of the valve cap of FIG. 12;

FIG. 15 is a rear view of the module of FIG. 3 configured with PCR reaction chambers as a PCR assay cartridge;

FIG. 16 is a front view of the PCR assay cartridge of FIG. 15;

FIG. 17 is an isometric view of a PCR reaction chamber that may be associated with some embodiments of the PCR assay cartridge of FIG. 15;

FIG. 18 is a front view of the module in FIG. 3 configured as an immunoassay module with an immunoassay reaction chamber;

FIG. 19 is a rear view of the immunoassay module in FIG. 18;

FIG. 20 is an assembly view of the immunoassay assay module of FIG. 18;

FIG. 21 is an assembly view of the reaction chamber of FIG. 20;

FIG. 22 is a front view of the reaction chamber in FIG. 20;

FIG. 23 is a front view of the module in FIG. 3 configured as a lateral-flow assay module with a lateral-flow reaction chamber;

FIG. 24 is a rear view of the lateral-flow assay module of FIG. 23;

FIG. 25 is an assembly view of a lateral-flow reaction chamber that may be associated with some embodiments of the module of FIG. 23;

FIG. 26 is another isometric view of the lateral-flow reaction chamber of FIG. 25;

FIG. 27 is a rear view of the module in FIG. 3 configured as an electrochemical bioassay module with an electrochemical bioassay chamber;

FIG. 28 is a front view of the electrochemical bioassay module of FIG. 27;

FIG. 29 is an isometric view of an electrochemical bioassay chamber that may be associated with some embodiments of the module of FIG. 27;

FIG. 30 is an isometric view of an assay reader that may be associated with some embodiments of the system of FIG. 1;

FIG. 31 is a block diagram of major components that may be associated with some embodiments of the assay reader of FIG. 30;

FIG. 32 is a front view of the assay reader of FIG. 30 with the cover removed to expose the components;

FIG. 33 is a rear view of the assay reader of FIG. 32;

FIG. 34 is an isometric view of the assay reader of FIG. 32 with an assay cartridge partially inserted;

FIG. 35 is an isometric view of the assay reader of FIG. 33 with an assay cartridge partially inserted; and

FIG. 36 is an isometric view of the backside of the assay reader of FIG. 33 with a transparent heater module housing and with an assay cartridge fully inserted into the assay reader.

### DETAILED DESCRIPTION OF ILLUSTRATIVE EMBODIMENTS

The following description of example embodiments provides information that enables a person skilled in the art to make and use the subject matter set forth in the appended claims, but it may omit certain details already well known in the art. The following detailed description is, therefore, to be taken as illustrative and not limiting.

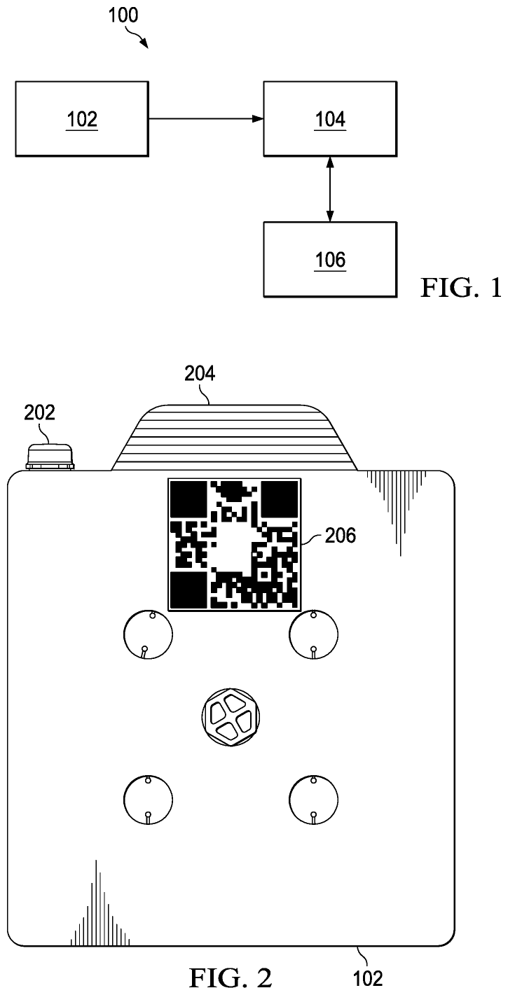

FIG. 1 is a simplified block diagram of a system 100 that can provide automated, economical, portable diagnostic assays and can be reconfigured to run different types of diagnostic assays, such as PCR assays and immunoassays. The system 100 of FIG. 1 comprises an assay cartridge 102 that can be configured to perform different types of diagnostic assays and an assay reader 104 that can be configured to run the specific assay for which the assay cartridge 102 is configured. The assay cartridge 102 can be inserted into the assay reader 104 to run an assay. A smart phone 106 with a diagnostic assay protocol application can communicate with the assay reader 104 via wireless communication, such as Wi-Fi and/or Bluetooth, to provide the appropriate protocol instructions to run the assay, to collect and analyze data from the assay reader 104, and to report and store assay results.

FIG. 2 is a front view of an example of the assay cartridge 102, illustrating additional details that may be associated with some embodiments. For example, a QR code 206 can enable the assay reader 104 or the smart phone 106 to identify the specific test to be run. A handle 204 on top of the assay cartridge 102 facilitates insertion of the assay cartridge 102 into the assay reader 104.

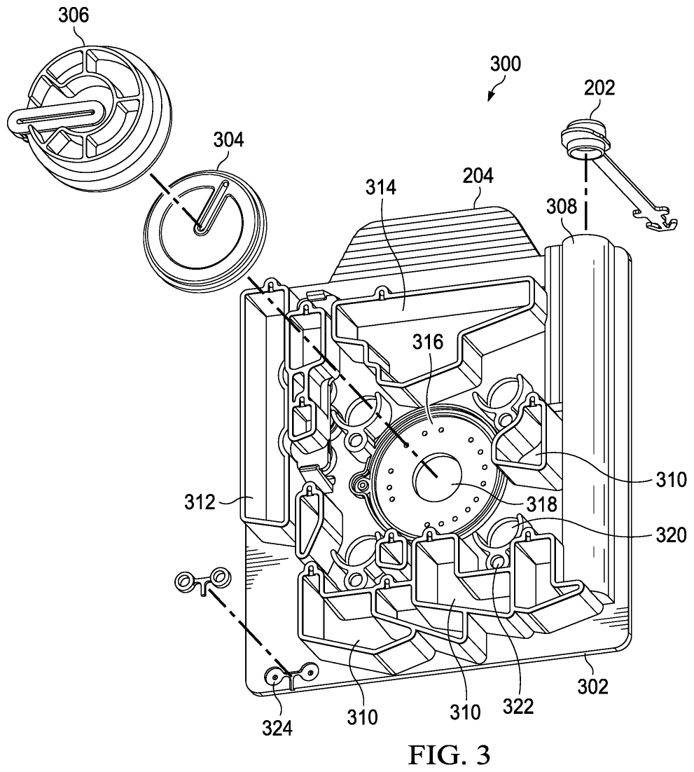

FIG. 3 is an assembly view of an example of an assay module 300 that may be associated with some examples of the cartridge 102 of FIG. 2. As illustrated in the example of FIG. 3, some embodiments of the assay module 300 may comprise a valve cap 306, a valve 304, and a cartridge base 302. In some examples, the cartridge base 302 may be injection molded. A number of chambers can be molded into the cartridge base 302. For example, reagent chambers 310, a mixing chamber 312, a waste chamber 314, and other chambers are molded into the cartridge base 302 of FIG. 3. A sample collection chamber 308 and a sample collection chamber cap 202 may also be integral to some embodiments of the cartridge base 302, as illustrated in the example of FIG. 3. The valve cap 306 can secure the valve 304 in a valve housing 316 of the cartridge base 302. Reaction-chamber openings 320 in the cartridge base 302 can each accommodate a reaction chamber. In some embodiments, a different reaction chamber can be used for PCR, lateral-flow assays, competitive binding, and electrochemical bioassays, for example. A reaction chamber can plug into a female reaction-chamber port 322 to connect it to the cartridge base 302. The cartridge base 302 may additionally comprise a pneumatic port 324, which can be coupled to a pneumatic pump for operation.

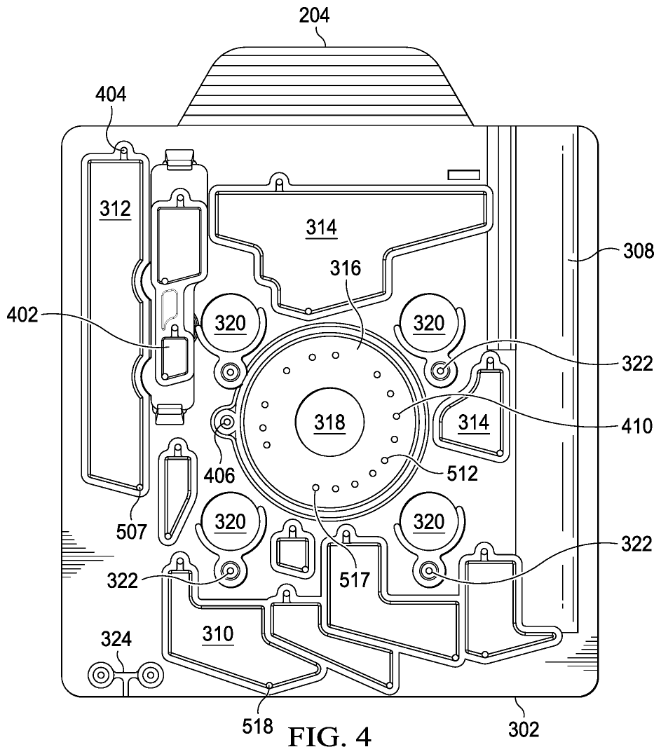

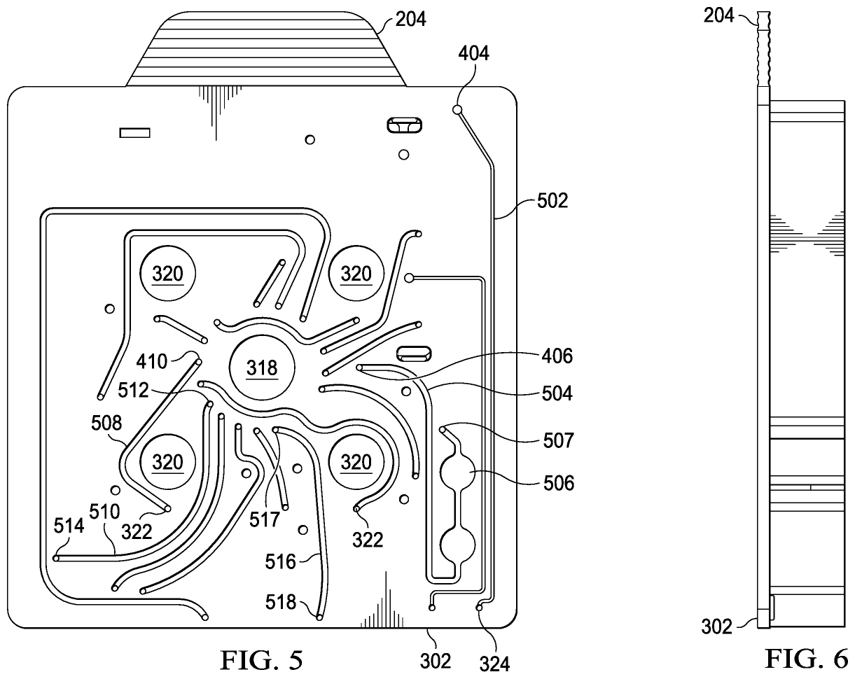

FIGS. 4 and 5 are rear and front views of the cartridge base 302 of FIG. 3. FIG. 6 is a side view of the cartridge base 302. The cartridge base 302 may be reconfigured for a variety of assays. For example, liquid or freeze-dried assay reagents specific to an assay being run may be sealed into reagent chambers 310, and magnetic beads designed to capture DNA molecules may be sealed in a bead chamber 402. Each of the reaction-chamber ports 322 may be configured to receive a reaction chamber for a specific assay. For example, assay-specific reaction chambers can be plugged into the female reaction-chamber ports 322 next to openings 320 in the assay cartridge base 302. The openings 320 can enable detectors to monitor reactions in the reaction chambers. As illustrated in the example of FIG. 4 and FIG. 5, a microchannel 502 can fluidly couple the mixing chamber 312 to the pneumatic port 324 through inlet/outlet hole 404.

The cartridge base 302 may be molded with different designs. In some examples, the cartridge base 302 can have multiple reagent chambers 310. These reagent chambers 310 can be prefilled with liquid or freeze-dried reagents for specific assays. Chamber 402 can be prefilled with magnetic beads functionalized for a specific assay. The cartridge base 302 can also have chambers for other purposes, such as a chamber 506 for capturing magnetic beads. For example, the chamber 506 may be fluidly coupled to the mixing chamber 312 through hole 507 and configured to capture magnetic beads. Assay-specific reaction chambers can be plugged into the female reaction-chamber ports 322 next to reaction-chamber openings 320 to configure the assay module 300 for different assays.

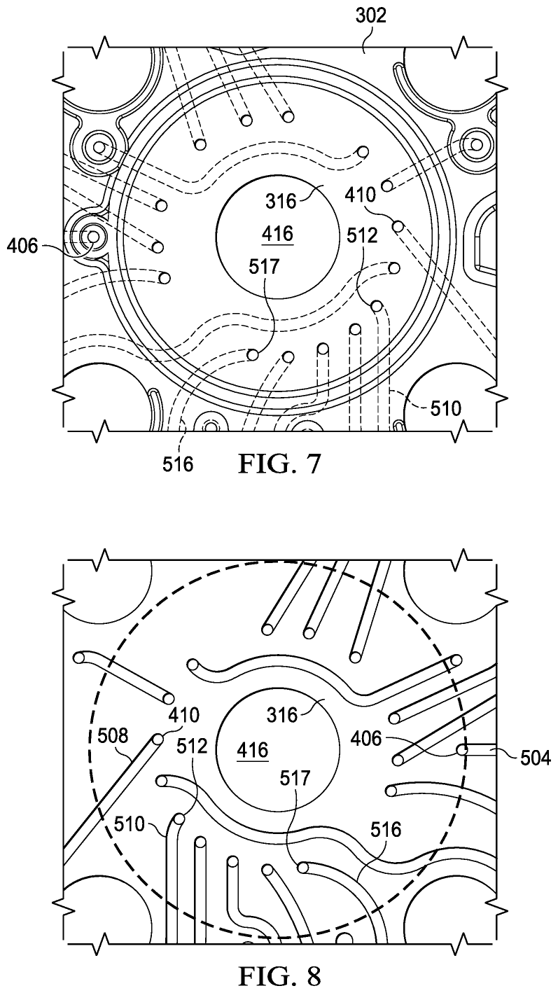

FIG. 7 and FIG. 8 are detail views of the valve housing 316 of FIG. 4, illustrating additional details that may be associated with some embodiments. In the example of FIG. 7 and FIG. 8, the valve housing 316 is molded in the cartridge base 302 to accommodate the valve 304 and valve cap 306.

A plurality of inlet/outlet holes in the base of the valve housing 316 can be fluidly coupled to the various reagent chambers 310 and reaction chambers, and to the pneumatic port 324. For example, a microchannel 504 can fluidly couple the valve cap port 406 to the mixing chamber 312 (FIG. 4) through the bead capture chambers 506 and the hole 507 (FIG. 5), and a microchannel 508 can fluidly couple a hole 410 to the reaction-chamber port 322 (FIG. 4). A microchannel 510 can also fluidly couple a hole 512 in the valve housing 316 to the sample collection chamber 308 (FIG. 4) through a hole 514 (FIG. 5). Likewise, a microchannel 516 can fluidly couple a hole 517 in the valve housing 316 to the reagent chamber 310 (FIG. 4) through a hole 518.

In some examples, the holes may be disposed in a circular pattern around a perimeter of the valve housing 316. In more particular examples, the holes may be on the same diameter circle near the outer circumference of the valve 304.

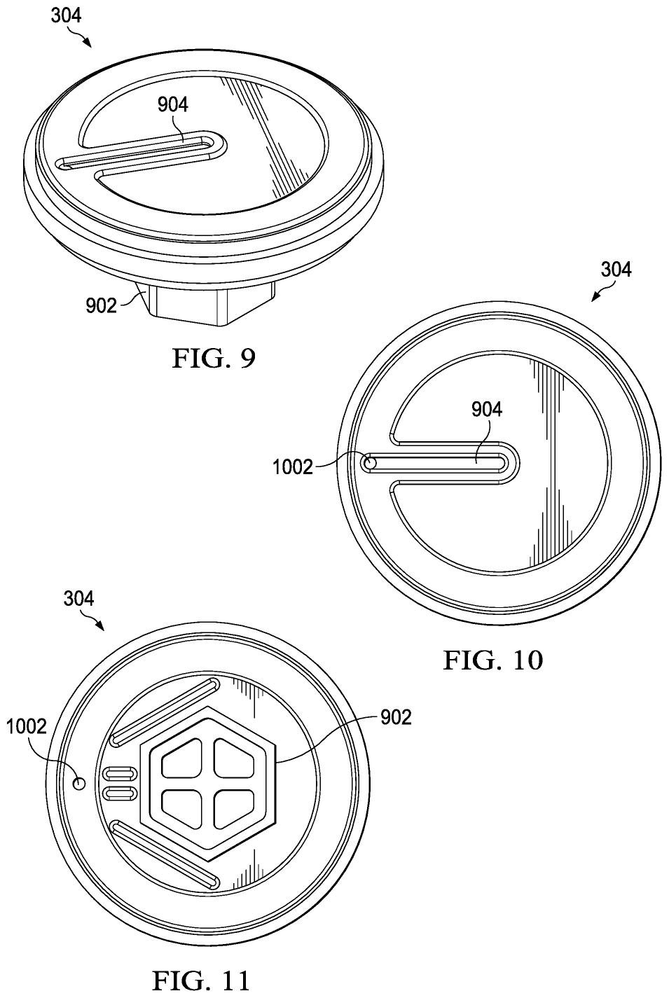

The valve 304 of FIG. 3 is shown in greater detail in FIGS. 9, 10, and 11. As shown in these examples, some embodiments of the valve 304 may be a rotary valve. The valve 304 may have a valve interface, such as an axle 902, which can be inserted through a central opening 318 in the valve housing 316 (FIG. 3). Other designs for the valve 304 are possible. For example, some embodiments of the valve 304 may have a curved microchannel that connects one of the holes in the valve housing 316 with another hole in the valve housing 316. For example, a curved microchannel in the valve 304 could connect hole 512 to hole 517 when the valve is rotated into the proper position. The axle 902 of FIG. 11 is hexagonal, but other shapes may be suitable. As shown in the example of FIG. 9 and FIG. 10, a valve microchannel 904 runs from the top center of the valve 304 to a hole 1002 near the outer perimeter of the valve 304. The valve 304 may be operated to selectively couple the hole 1002 to one of the holes in the base of the valve housing 316.

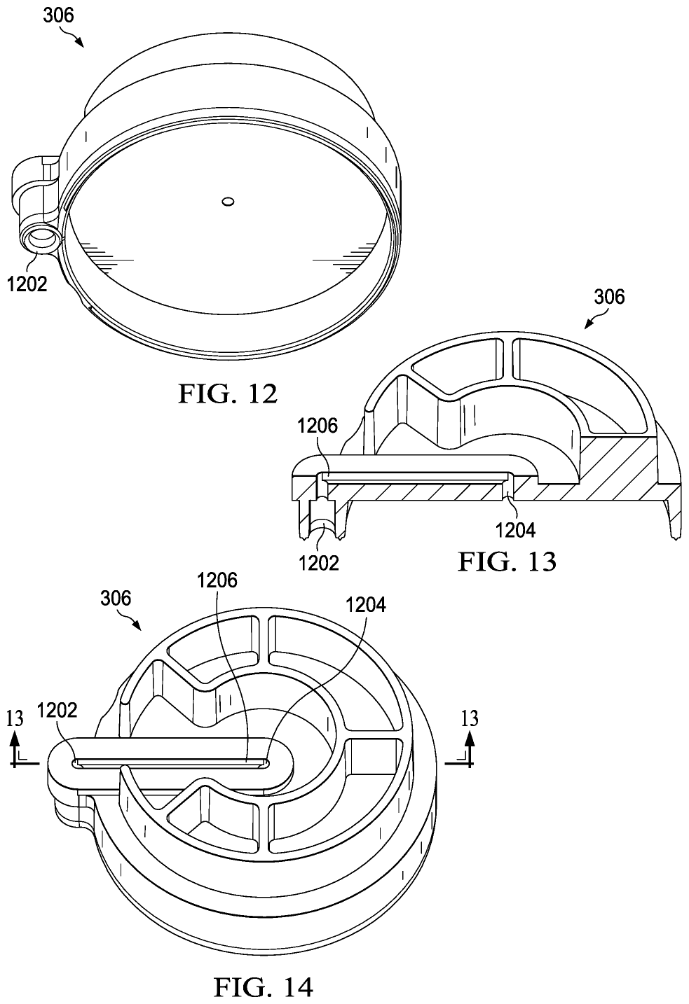

The valve cap 306 is shown in more detail in FIGS. 12, 13, and 14. The valve cap 306 can retain the valve 304 in place in the valve housing 316 on the cartridge base 302. A cap microchannel 1206 across a top circumference of the valve cap 306 can fluidly connect a fluid shaft 1202 along the outside vertical side of the valve cap 306 to a hole 1204 in the center of the top of the valve cap 306. The valve cap 306 may be placed over the valve 304 to fluidly couple the cap microchannel 1206 in the valve cap 306 to the valve microchannel 904 in the valve 304 through the hole 1204. Fluid shaft 1202 may be coupled to the valve cap port 406 (FIG. 7) in the valve housing 316, thereby fluidly coupling the valve 304 to the mixing chamber 312. The valve cap 306 can deliver fluid, such as reagents, air, and vacuum, to the valve 304. The valve 304 can be operated to selectively couple the mixing chamber 312 to the sample collection chamber 308, one of the reagent chambers 310, and one of the reaction-chamber ports 322. For example, in some embodiments, the valve 304 can be rotated about the axle 902 to a predetermined position that aligns with an appropriate hole, such as hole 410, in the valve housing 316. By rotating the valve 304 to align with the appropriate hole in the valve housing 316, fluid can be delivered to a desired chamber (e.g., reagent, mixing, bead capture, reaction, waste chambers).

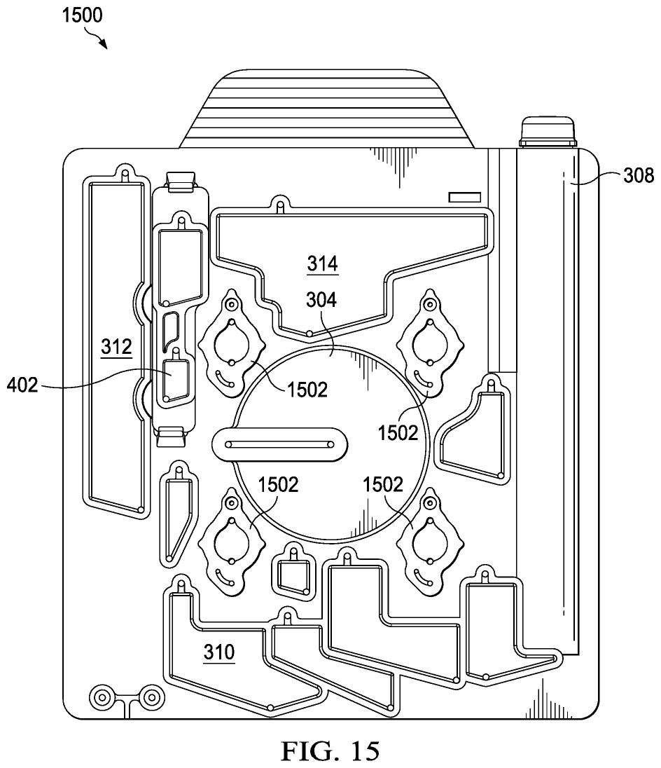

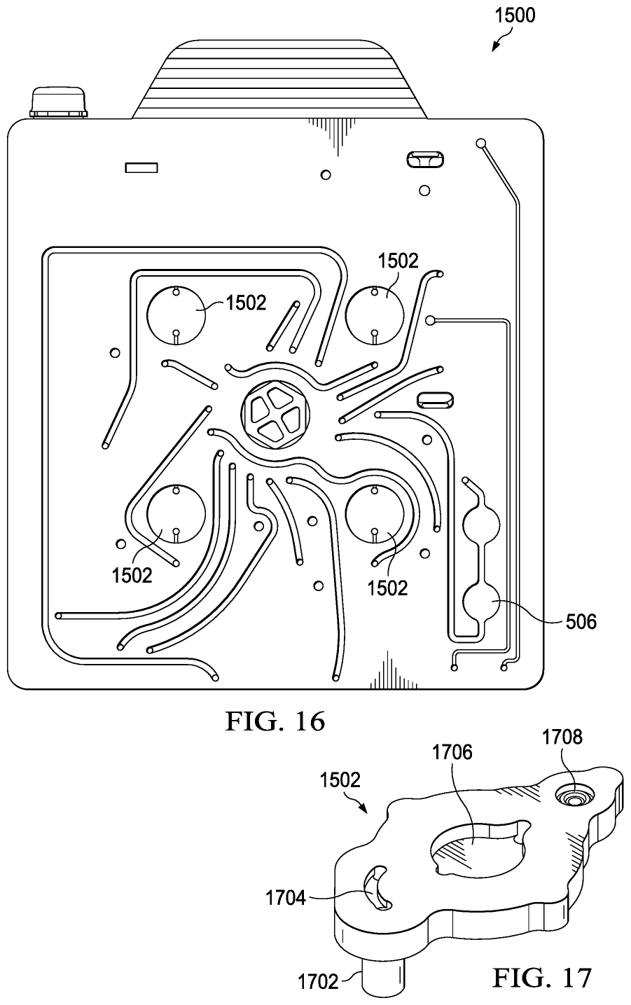

FIGS. 15 and 16 are rear and front views of an example of a PCR assay module 1500, which comprises the assay module 300 of FIG. 3 configured with PCR reaction chambers 1502. FIG. 17 is an isometric view of one of the PCR reaction chambers 1502, illustrating additional details that may be associated with some embodiments. For example, the PCR reaction chamber 1502 of FIG. 17 comprises a PCR chamber shaft 1702, which can be inserted into the female reaction-chamber port 322 (FIG. 3) in the module 300. In the example of FIGS. 15 and 16, up to four PCR reaction chambers 1502 can be mounted. Assay mixture can be introduced into the PCR reaction volume 1706 through the PCR chamber shaft 1702 and microchannel 1704. Vent 1708 allows air to escape while the PCR reaction volume 1706 is being filled. The PCR reaction chamber 1502 can be made of a material such as polycarbonate, or acrylic that is transparent to light.

The reagent chambers 310 in the cartridge base 302 can be pre-filled with either liquid or freeze-dried reagents specific to a PCR assay. Bead chamber 402 can be pre-filled with magnetic beads functionalized for the specific PCR diagnostic assay. The PCR assay can be run using well-established protocols. For example, a sample swab can be inserted into the sample collection chamber 308 and the sample can be dissolved in buffer. The sample/buffer solution can be mixed with lysis reagents and pneumatically moved into the mixing chamber 312 where it can be heated to facilitate lysis. The lysed sample can be mixed with magnetic beads that capture DNA and DNA fragments. DNA and DNA fragments in the lysed sample can bind to surfaces of the magnetic beads. The magnetic beads can then be immobilized in the magnetic bead capture chambers 506 by magnets in the assay reader 104. The sample/buffer solution can be sent to the waste chamber 314 and the magnetic beads can be washed with buffer. DNA and DNA fragments captured on the magnetic beads can be released from the magnetic beads and combined with a PCR master mix to form the PCR assay solution. The master mix contains the chemicals and enzymes needed to run the PCR reaction. Lyophilized target-specific DNA primers can be preloaded into the PCR reaction chambers. The PCR assay solution can be introduced into the PCR reaction chambers 1502 and can dissolve lyophilized DNA primers. If target DNA or DNA fragments are present in the PCR assay sample, they can be multiplied (amplified) during the PCR reaction. If target DNA or target DNA fragments are not in the sample, no DNA amplification may occur.

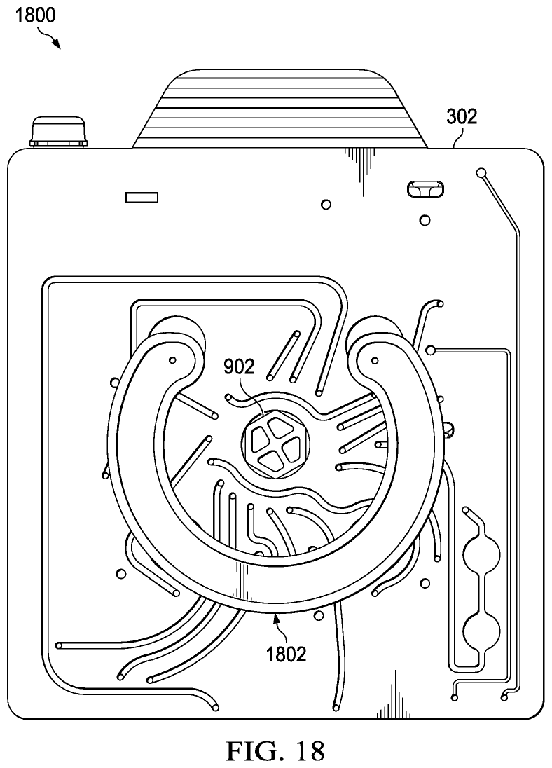

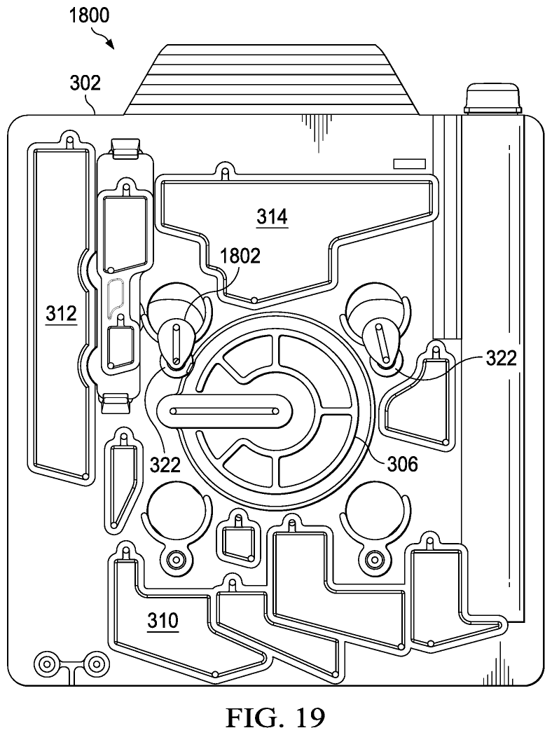

FIGS. 18 and 19 are front and rear views of an example of an immunoassay module 1800, which comprises the assay module 300 of FIG. 3 configured with an immunoassay reaction chamber 1802. The immunoassay module 1800 can be configured to perform antibody/antigen sandwich assays and competitive binding (CB) immunoassays.

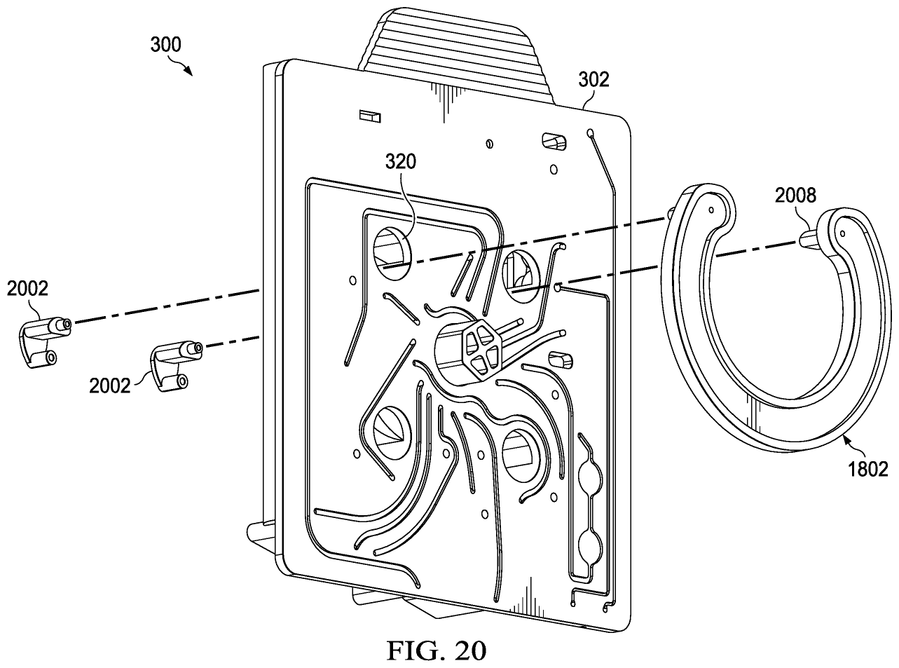

As shown in FIG. 20, shafts 2008 on the underside of the immunoassay reaction chamber 1802 can be inserted through the reaction-chamber openings 320 from the frontside of the assay module 300. In some embodiments, the shafts 2008 may receive couplers 2002 through the reaction-chamber openings 320. The couplers 2002 may have a U-shape and can also be coupled to the female reaction-chamber ports 322 to connect the immunoassay reaction chamber 1802 to the assay module 300.

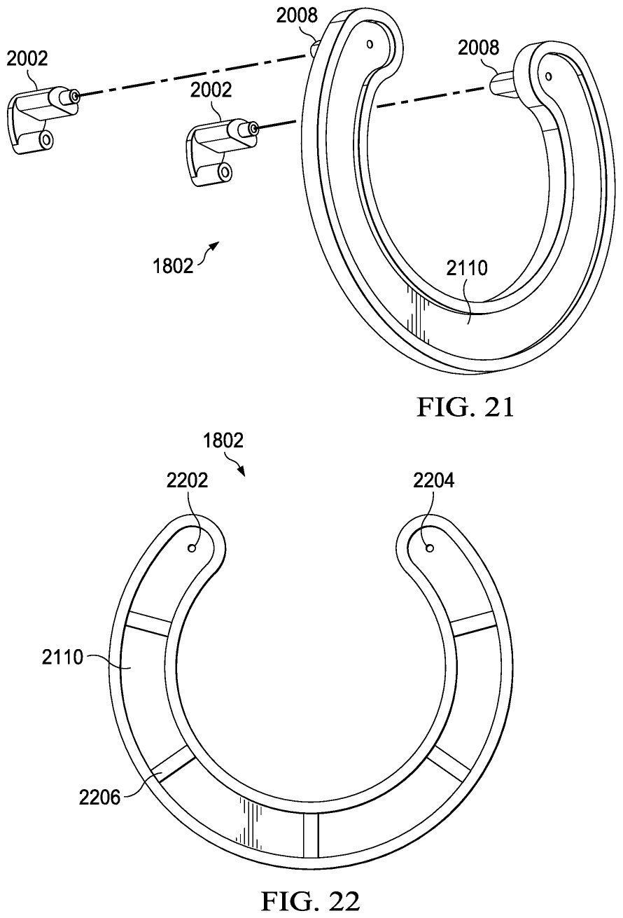

The immunoassay reaction chamber 1802 is shown in more detail in FIGS. 21 and 22. From the backside of the immunoassay reaction chamber 1802, the couplers 2002 can be inserted into to the shafts 2008 projecting from the immunoassay reaction chamber 1802 and inserted into the female reaction-chamber ports 322, thereby coupling the immunoassay reaction chamber 1802 to the cartridge base 302. In some embodiments, the immunoassay reaction chamber 1802 may comprise an assay tray 2110 with an inlet hole 2202 at one end and an outlet hole 2204 at the other end. As illustrated in the example of FIG. 21, some embodiments of the assay tray 2110 may be a shallow, semicircular recess in the immunoassay reaction chamber 1802. As illustrated in FIG. 22, several stripes of a first antibody 2206 can be immobilized along the assay tray 2110 at various locations.

The reagent chambers 310 on the module 300 can be prefilled with liquid wash buffers and liquid or lyophilized reagents for specific immunoassays.

In operation of a sandwich immunoassay, assay mixture of sample and reagents can be prepared in the mixing chamber 312 and can be directed by the valve 304 to flow through input/output hole 410 and through microchannel 508 to the reaction-chamber port 322. The reaction-chamber port 322 is fluidly coupled to the tray 2110 through the coupler 2002, the shaft 2008, and hole 2202. The assay mixture can enter the shallow tray 2110 of the immunoassay reaction chamber 1802 through inlet hole 2202 and exit through outlet hole 2204. If the antigen (target protein) is in the immunoassay sample, it can be captured by the appropriate immobilized stripe of the first antibody 2206. After the sample has passed all the immobilized stripes of first antibodies 2206, the assay tray 2110 can be washed with a buffer solution. A solution of tagged second antibodies can then be passed over the immobilized stripes of the first antibodies 2206. The tagged second antibody can attach to antigens (target proteins) captured by the first antibodies 2206 forming a second antibody/target protein/first antibody sandwich. If the tag is an optically active tag, such as a fluorescence or phosphorescence tag, an optical detector mounted in the assay reader 104 can be moved along the circumference of the immunoassay reaction chamber 1802 to detect which of the stripes of the first antibody 2206 have also captured tagged second antibodies. When the tag is an enzyme, the sandwich complex can be washed with buffer solution and then immersed in a substrate solution. The enzyme reacts with the substrate to produce a color which can be optically detected.

In a competitive binding assay, tagged antigens (target proteins) to the specific antibodies immobilized in stripes of the first antibody 2206 on the immunoassay reaction chamber 1802 can be mixed with the sample before being pumped into the assay tray 2110. If untagged antigen (target protein) is present in the patient sample, the stripe of the immobilized first antibody 2206 can capture untagged antigen (target protein) as well as tagged protein. The untagged antigen (target protein) in the sample competes with the tagged antigen (tagged target protein) for antibody binding sites. After allowing sufficient time for the sample to react with the stripes of immobilized antibodies 2206, the assay tray 2110 can be washed with buffer and the tagged antigens (target proteins) that were captured can be detected. If the tag is an optically active tag, such as a fluorescence or phosphorescence tag, an optical detector mounted in the assay reader 104 can be moved along the circumference of the immunoassay reaction chamber 1802 to detect which of the immobilized antibody stripes 2206 have captured untagged antigens (target proteins) in addition to the tagged antigens (target proteins). Target antigens (target proteins) in the sample compete with tagged antigens introduced into the sample for antibody binding sites. The higher the concentration of antigens (target proteins) in the sample, the lower the signal.

Immobilized antigens (target proteins) and tagged antibodies can equally well be used in diagnostic assays for detecting target antibodies in a sample.

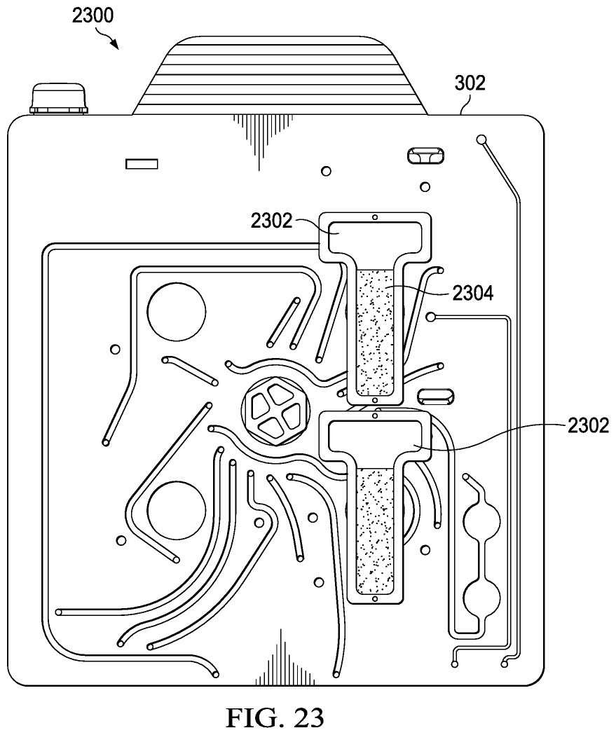

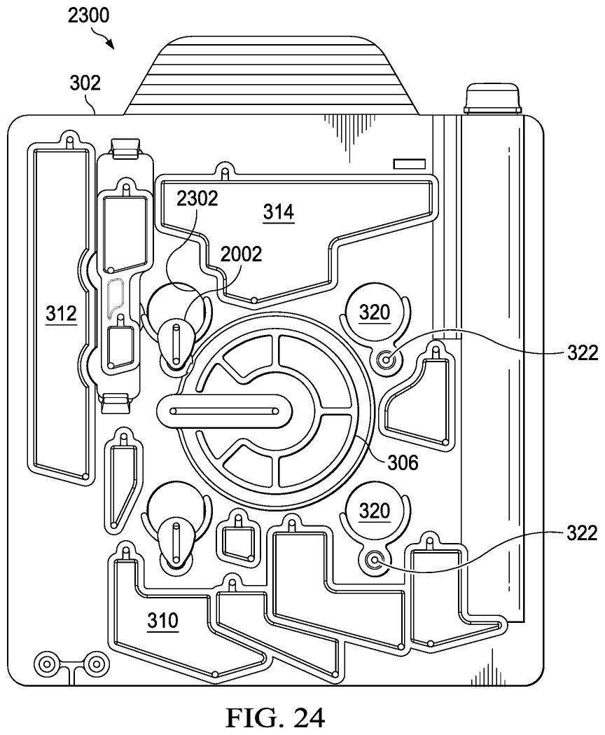

FIGS. 23 and 24 are front and rear views of an example of a lateral-flow assay module 2300, which comprises the module 300 of FIG. 3 configured with lateral-flow reaction chambers 2302.

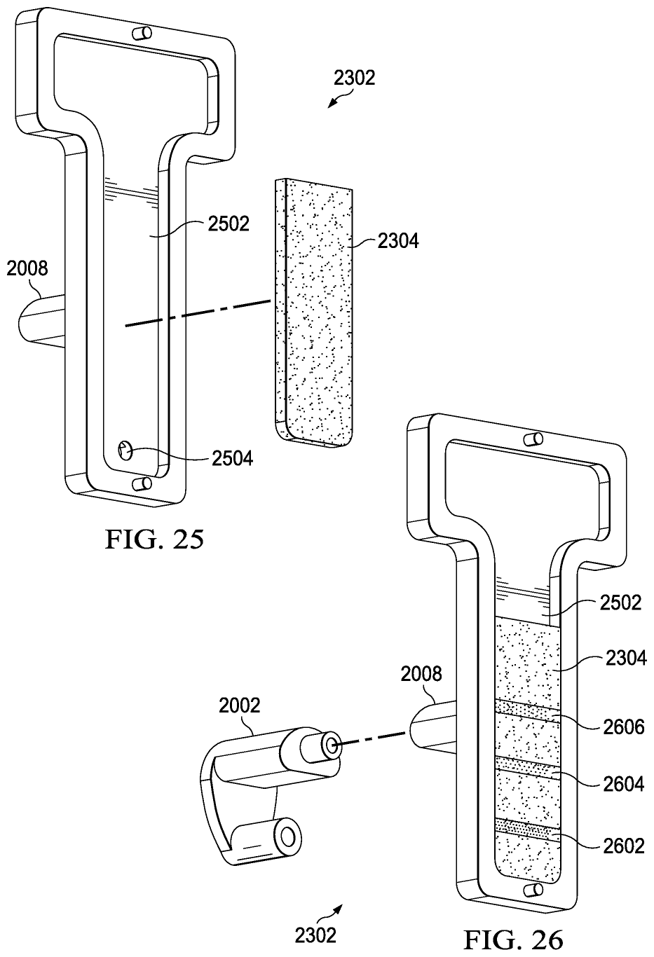

FIGS. 25 and 26 are assembly views of an example of the lateral-flow reaction chamber 2302, illustrating additional details that may be associated with some embodiments. The lateral-flow reaction chamber 2302 of FIGS. 25 and 26 comprise a tray 2502, which can be filled with a wicking pad 2304 embedded with lateral-flow reagents. The lateral-flow reagents can be a band of tagged first antibodies that are mobile plus one or more bands 2606 of immobilized second antibodies spaced along the wicking pad 2304. In the example of FIGS. 25 and 26, the tray 2502 is a shallow recess in an exterior surface of the lateral-flow reaction chamber 2302. A shaft 2008 projecting from the underside of the lateral-flow reaction chamber 2302 can be connected to an inlet hole 2504 at one end of the shallow tray 2502. For example, in some embodiments, a microchannel (not visible in FIGS. 25 and 26) on the underside of the lateral-flow reaction chamber 2302 may fluidly couple the shaft 2008 to the inlet hole 2504. The shaft 2008 can be inserted through the reaction-chamber opening 320 from the front side of the module 300. From the rear side of the module 300, one end of the coupler 2002 can be inserted into the shaft 2008, and the other end of the coupler 2002 can be inserted into the female reaction-chamber port 322, thereby coupling the lateral-flow reaction chamber 2302 to the module 300.

In operation, an assay mixture of sample and reagents prepared in the mixing chamber 312 of the lateral-flow assay module 2300 can be directed by the valve 304 to flow through input/output hole 410 and through microchannel 508 to the reaction-chamber port 322. The assay mixture can then enter the lateral-flow reaction chamber 2302 through shaft 2008 and through inlet hole 2504 and wet the wicking pad 2304. As the sample travels along the wicking pad 2304, it encounters a band of mobile, tagged first antibodies 2602. Commonly used tags are latex microspheres which are blue in color or gold microspheres which are red in color. If the sample contains the antigen (target protein) of interest, these tagged first antibodies 2602 bind to the antigen and move with the antigen as it moves along the wicking pad 2304. As the sample travels along the wicking pad 2304, it encounters one or more bands, 2604 and 2606, of immobilized second antibodies. If the sample contains the antigen of interest, the band, 2604 or 2606 of second immobilized antibodies will capture the antigen/tagged first antibody complex and a band of color will develop across the wicking pad 2304. This band of color can be detected optically by a colorimeter or CCD camera in the assay reader 104.

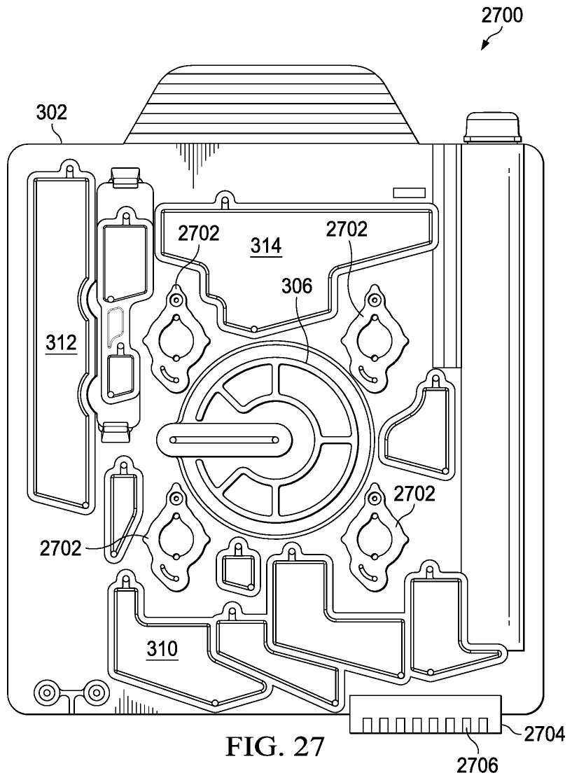

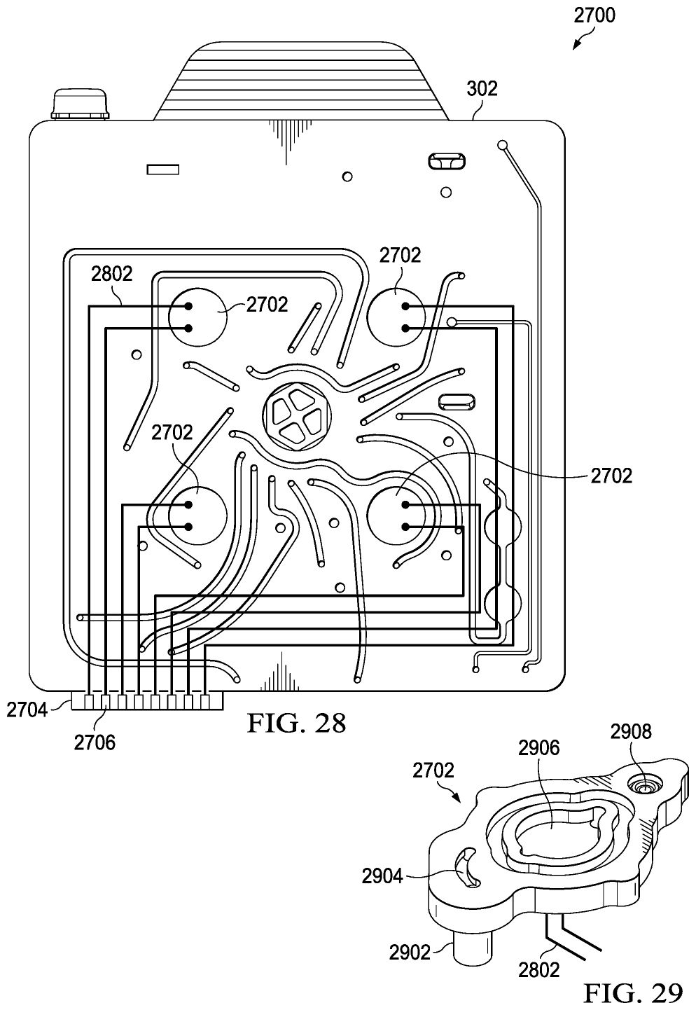

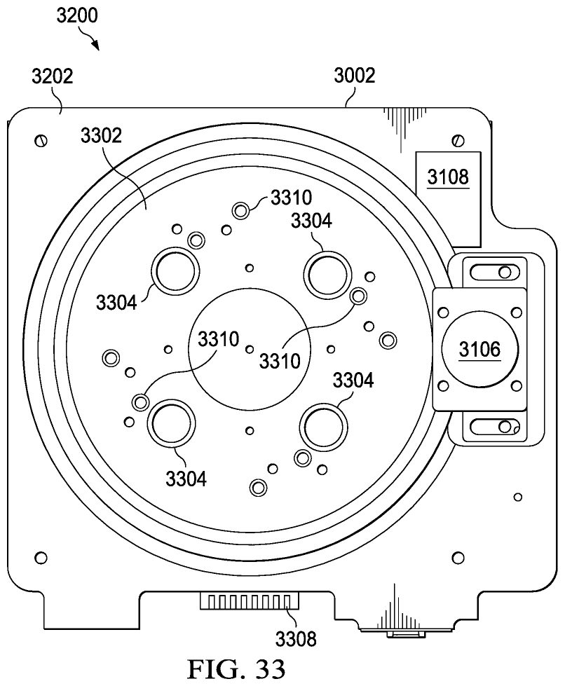

FIGS. 27 and 28 are rear and front views of an electrochemical bioassay module 2700, which comprises the assay module 300 of FIG. 3 configured with electrochemical reaction chambers 2702. An isometric view of the electrochemical reaction chamber 2702 is shown in FIG. 29. A shaft 2902 projecting from the underside of the electrochemical reaction chamber 2702 of FIG. 29 can be inserted into the female reaction-chamber port 322 adjacent to the reaction-chamber opening 320 to mount it on the assay module 2700. A microchannel 2904 can connect the shaft 2902 to the electrochemical reaction volume 2906. Vent 2908 can allow air to escape as the reaction volume 2906 fills. Wires 2802 can connect electrical sensors within the electrochemical reaction volume 2906 to leads 2706 on a circuit board connector 2704 mounted on the electrochemical bioassay module 2700. The circuit board connector 2704 can be plugged into an electrochemical bioassay receptacle 3308 (FIG. 33) in the assay reader 104. If PCR mix containing electrically charged template DNA or RNA (Nucleic acids) enters the reaction volume 2906 through the shaft 2902 and microchannel 2904, an electrical parameter such as impedance can be read by the electrical sensors. This measured impedance value can be the base reading of a PCR reaction that has yet to take place; similar to the base fluorescent reading measured in classic PCR assays. During PCR thermal cycling, in the presence of target nucleic acid (DNA or RNA), the number of strands of DNA or RNA increases in the electrochemical reaction volume 2906, effectively increasing the concentration of charged species. This increase in concentration of charged nucleic acid bodies can result in a change in an electrical parameter, such as impedance, which can be reliably detected using the electrical sensors. This impedimetric detection of PCR can be as sensitive, or more sensitive than classical fluorescence-based PCR detection. Additionally, the hardware setup may be far simpler and less costly, as complex optics can be avoided with electrochemical bioassay detection. Alternatively other electrical parameters can be used for detection, such as voltammetric detection, where the electrical sensor can detect changes in the potential difference with a constant current flowing through the electrical array in the reaction chamber, or amperometric detection, where the electrical sensor can detect changes in current flowing while a constant potential difference is maintained in the reaction chamber.

Additionally, electrochemical detection methods can be used for immunoassays where the antibodies are immobilized on an electrical array on the surface of the reaction chamber. With each binding step (antigen, primary antibody, secondary antibody, etc), the impedance change caused by the change in biochemistry can be precisely quantified as a function of change in impedance measured through the electrical leads 2706 and circuit board connector 2704 as shown in FIG. 27 and FIG. 28. If the presence of target antibody/antigen is detected, the change in impedance due to binding of these target molecules to the immobilized antibody can be easily and precisely detected. The same electrical circuitry can be used for both nucleotide detections such as in PCR to detect target antibodies or antigens in immunoassays.

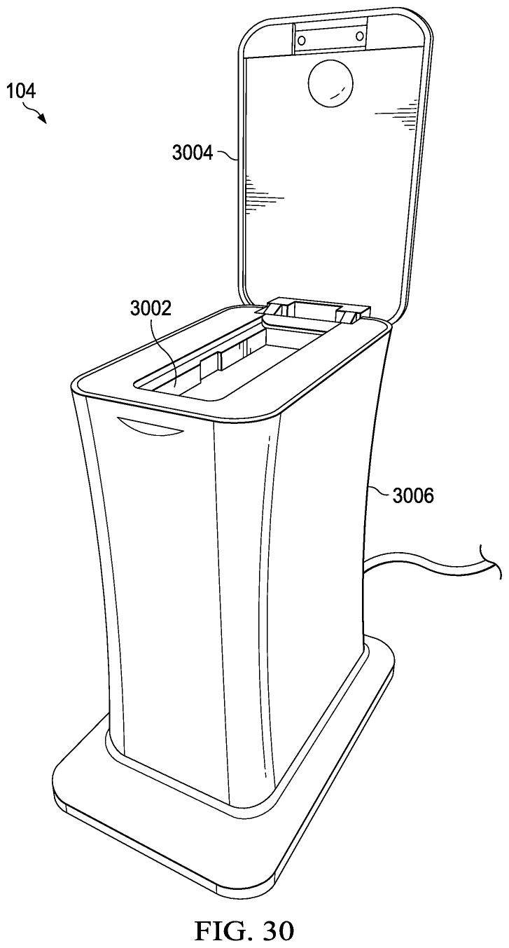

FIG. 30 is an isometric view of an example of the assay reader 104, illustrating additional details that may be associated with some embodiments. For example, the assay reader 104 may comprise a slot 3002 that may be exposed by removing or opening a lid 3004 attached to a housing 3006. The assay cartridge 102 can be inserted into the slot 3002 to run a diagnostic assay.

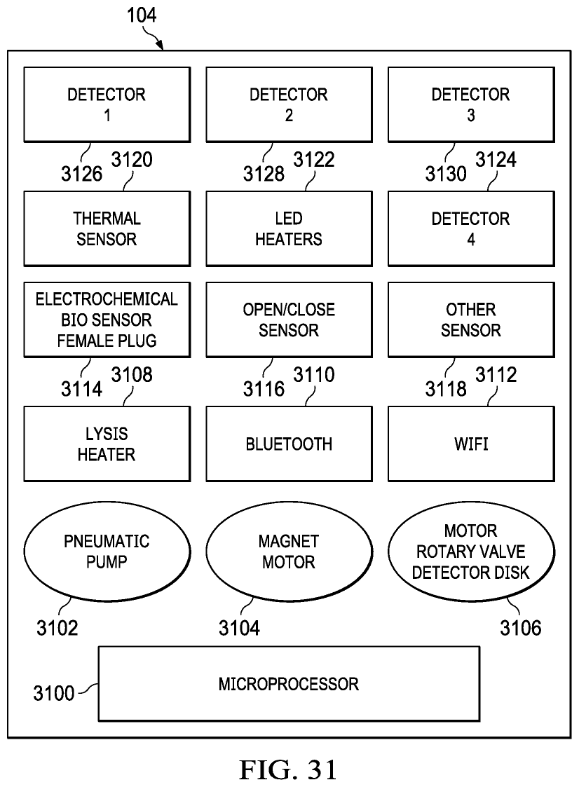

FIG. 31 is a block diagram of example components that may be associated with some embodiments of the assay reader 104.

For example, a controller or processor, such as a microprocessor 3100, may be coupled to one or more communication interfaces, including wireless communication interfaces, such as a transceiver 3110 and/or transceiver 3112. In some examples, the transceiver 3110 and the transceiver 3112 may conform to one or more wireless technology standards, such as Bluetooth and Wi-Fi. The transceiver 3110, the transceiver 3112, or both may be configured to communicate with the smart phone 106 (see FIG. 1) to receive an assay protocol and send assay data in some embodiments. For example, the smart phone 106 may be configured with an application that can provide assay protocols to and analyze assay data from the assay reader 104.

The microprocessor 3100 can also operate a pneumatic pump 3102, which can provide positive pressure, negative pressure, or both, to move fluids through micro-channels in the assay cartridge 102. The microprocessor 3100 can also operate a magnet motor 3104, which can capture and release magnetic microbeads from the magnetic micro-bead capture chamber 506. In other embodiments, the microprocessor 3100 may operate a solenoid instead of or in addition to the magnet motor 3104. The microprocessor 3100 also may operate a lysis heater module 3108 to heat the mixing chamber 312 during lysis of the sample and also heat the mixing chamber 312 to facilitate diagnostic chemical reactions. The microprocessor 3100 can control the LED heaters 3122 and use feedback from thermal sensors 3120 to control the temperature during diagnostic assay reactions, such as PCR temperature cycling. The microprocessor 3100 can receive electrical signals from various detectors such as optical sensors, electrochemical sensors, and CCD cameras, and can convert the signals to present or not present results or can convert the signals to the concentration of the target of interest. The microprocessor 3100 can interpret the data and present results on a display screen, send the data to the smart phone 106 for display on the smart phone screen, or both. The microprocessor 3100 can also operate a motor 3106, which can be coupled to and operate the valve interface to position the valve 304 and connect the appropriate micro-channels. The motor 3106 may also be operated to position the appropriate detector over the assay reaction chambers, such as the PCR reaction chamber 1502, the immunoassay reaction chamber 1802, or the lateral-flow reaction chamber 2302.

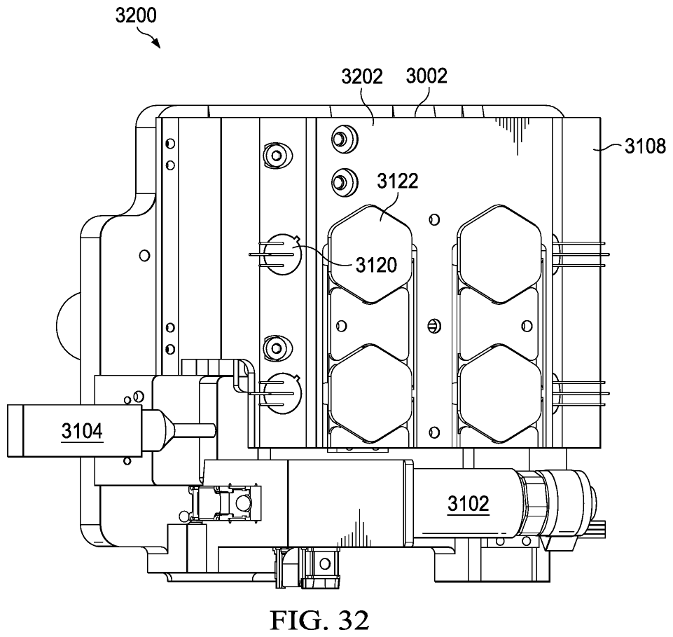

FIG. 32 is a rear view of an example of a reader platform 3200 that may be associated with some embodiments of the assay reader 104 in FIG. 30. For example, the reader platform 3200 may be an injection-molded mounting block 3202, upon which the LED heaters 3122 and the thermal sensors 3120 can be mounted. The reader platform 3200 can also be configured with the slot 3002 oriented as illustrated in FIG. 30. The lysis heater module 3108 can be attached to the mounting block 3202 for assays that require heating and thermal control or can be omitted, saving cost for assays that do not require heating and thermal control. Also shown attached to the mounting block 3202 are the magnet motor 3104 and the pneumatic pump 3102. The pneumatic pump 3102 may be configured to be coupled to a pneumatic port associated with an assay cartridge, such as the pneumatic port 324.

FIG. 33 is a front view of the reader platform 3200 of FIG. 32. The reader platform 3200 of FIG. 33 comprises a detector disk 3302, which has four detector openings 3304 configured to give detectors access to optical signals from the reaction chambers. The openings 3304 can be aligned with the reaction-chamber openings 320 in the module 300 when the detector disk motor 3106 rotates the detector disk 3302 into alignment. Also shown attached to the mounting block 3202 are the lysis heater module 3108 and the electrochemical bioassay receptacle 3308, which can be electrically coupled to the electrochemical bioassay module 2700 in FIG. 27 when the circuit board connector 2704 is inserted.

The detector disk 3302 can be configured to receive multiple detectors of different types. These may be detectors, such as optical detectors, CCD cameras, colorimetric detectors, fluorescent detectors, phosphorescent detectors, spectrometers. For example, the detector disk 3302 may have a plurality of mount points 3310 as shown in FIG. 33, which can receive various detectors as may be required for specific assays.

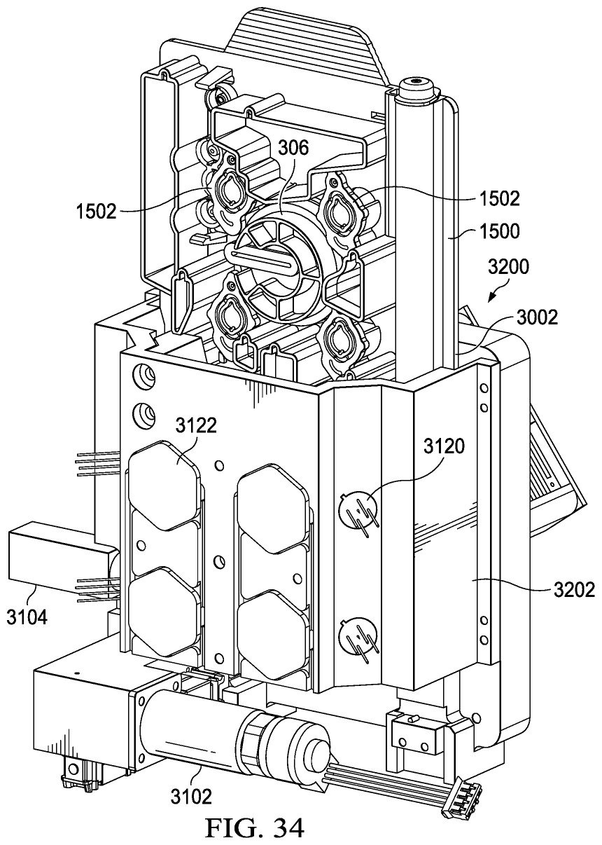

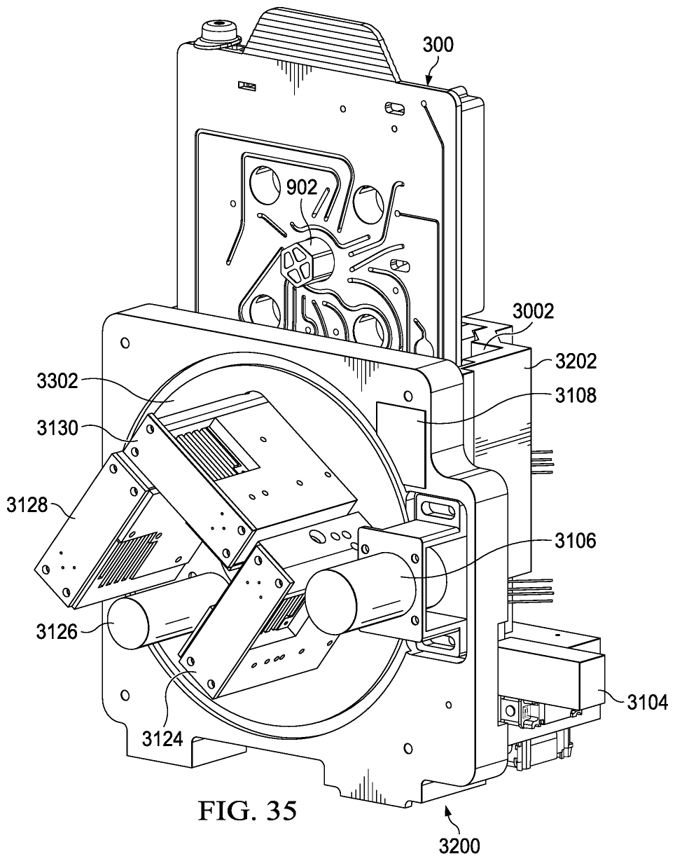

FIG. 34 is an isometric view the reader platform 3200 of FIG. 32 with the PCR assay module 1500 partially inserted into the slot 3002. LED heaters 3122 and thermal sensors 3120 are shown attached to mounting block 3202. Also shown are the pneumatic pump 3102 and the magnet motor 3104.

FIG. 35 is another isometric view of the reader platform 3200 of FIG. 33 with the PCR assay module 1500 partially inserted into the slot 3002. In the example of FIG. 35, four detectors 3124, 3126, 3128, and 3130 are mounted to the detector disk 3302. Depending upon the specific assay, different detectors can be selected and mounted. Optical detectors may include colorimeter, phosphorescence, and fluorescence detectors, for example. The optical detector can also be a spectrometer or a CCD camera with pattern recognition. The detector disk motor 3106 can rotate the detector disk 3302 about the valve axle 902 to position it over the desired reaction-chamber opening 320. The reaction chambers and the detectors can both be mounted on a circumference of the same circle to ensure proper alignment.

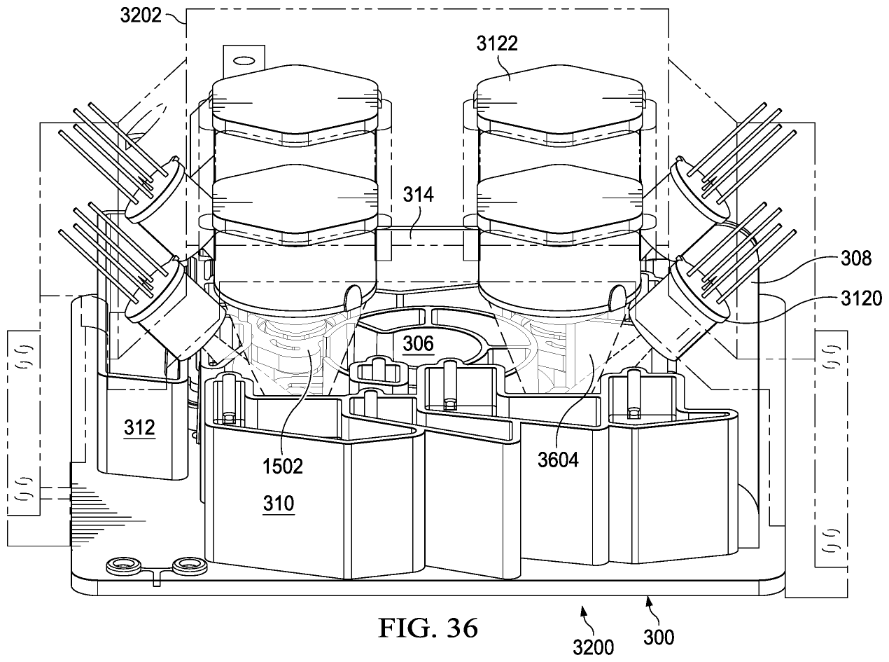

FIG. 36 is partially transparent view of the reader platform 3200 with the PCR assay module 1500 fully inserted. In FIG. 36, the mounting block 3202 is partially transparent for illustration purposes. LED heaters 3122 can be configured to project long-wavelength light 3604 onto a reaction chamber, such as the PCR reaction chamber 1502, to heat the reaction mixture inside. Thermal sensors 3120 coupled to the microprocessor 3100 monitor the temperature of the reaction mixture. The microprocessor 3100 can use feedback signals from the thermal sensors 3120 to control the LED heaters 3122 and maintain the proper reaction temperature.

In operation, one or more reaction chambers for a desired assay may be coupled to the module 300. For example, PCR reaction chambers 1502 may be inserted into each of the reaction-chamber openings 320 and fluidly coupled to the reaction-chamber ports 322, as illustrated in FIG. 34. A swab with a sample can be inserted into the sample collection chamber 308 of the module 300. The module 300 with the sample can be inserted into the slot 3002 to connect the pneumatic port 324 of the module 300 to the pneumatic pump 3102 and to connect the axle 902 to the motor 3106.

The microprocessor 3100 can be configured to operate the motor 3106 to rotate the axle 902 to align the hole 1002 and hole 512, thereby fluidly coupling the mixing chamber 312 to the sample collection chamber 308 through the microchannel 504, the valve microchannel 904, and the microchannel 510. Negative pressure from the pneumatic pump 3102 can be applied through the pneumatic port 324 to pull sample solution into the mixing chamber 312 from the sample collection chamber 308.

The microprocessor 3100 can then operate the motor 3106 to rotate the axle 902 to selectively couple the mixing chamber 312 to various chambers appropriate for the configured assay. For example, the axle 902 may be rotated to align the hole 1002 with the hole 517, thereby fluidly coupling the mixing chamber 312 to the reagent chamber 310. Negative pressure from the pneumatic pump 3102 can then pull the required assay reagents into the mixing chamber 312. After the sample is lysed, the valve 304 can be rotated to fluidly couple the bead chamber 402 to the mixing chamber 312, and functionalized magnetic beads from the bead chamber 402 can be pulled into the mixing chamber 312 to capture the DNA or protein target molecules of interest. The valve 304 can then be turned to fluidly couple the mixing chamber 312 to the bead capture chambers 506. Pressure from the pneumatic polls 324 can be applied to move the assay/magnetic bead mixture into the bead capture chambers 506. A magnet motor 3104 (FIG. 35) can move magnets into place to capture the magnetic beads with attached target molecules. The valve 304 can be rotated again to fluidly couple the mixing chamber 312 to the waste chamber 314, and waste assay mixture can then be disposed in the waste chamber 314. The magnetic beads with the target molecules can be released and re-suspended in wash buffer, and then returned to the mixing chamber 312 by applying negative pressure from pneumatic pump 3102 through pneumatic ports 324. For some assays, more than one washing of the magnetic beads plus target molecules may be required. After the final wash, the target molecules can be released from the magnetic beads using a release or a nucleotide eluting solution. The magnetic beads can then be recaptured in the bead capture chambers 506 by moving the magnets into place with the magnet motor 3104.

Assay solution such as a PCR master mix solution or an ELISA reagent solution can be mixed with the release/target molecule solution to form an assay mixture that is then introduced to the reaction chambers. For example, the valve 304 can be rotated to fluidly couple the mixing chamber 312 to one of the reaction-chamber polls 322, which can be fluidly coupled to a reaction chamber, such as the PCR reaction chamber 1502, the immunoassay reaction chamber 1802, the lateral-flow reaction chamber 2302, or the electrochemical reaction chamber 2702.

Detectors in the assay reader 104 such as optical detector 3130 (FIG. 35) can monitor the assay reactions through the reaction-chamber openings 320 in the module 300. The optical detector 3130 can read fluorescent signal being generated as the reaction progresses in the reaction chamber. The microprocessor can convert the intensity of the fluorescent signal into a concentration of the target DNA molecules in the assay. The microprocessor can then display the concentration on a user interface or sent to the smart phone for display. In PCR assays, fluorescent dyes that bind specifically to nucleotides can be included as a part of the lyophilized reagents in the PCR reaction chamber 1502. These fluorescent dyes can be probe-based nucleotide sequence-specific dyes or non-specific nucleotide dyes such as SYBR Green fluorescent dyes. As the DNA amplification reaction such as PCR progresses, the number of copies of target DNA increases. The fluorescent dye molecules attach specifically to the target molecules to produce stronger fluorescent signal. This signal is continuously monitored by the optical detector 3130 through reaction-chamber opening 320. The final signal strength can be compared to standard PCR reaction curve of known target concentration to determine the unknown concentration of target DNA being amplified, which can be displayed on a user interface of the assay reader 104 or sent to the smart phone 106 for display.

The systems, apparatuses, and methods described herein may provide significant advantages. For example, the automated, economical, portable diagnostic assay system described in this specification can be reconfigured to run a variety of both DNA based diagnostic assays (such as PCR and isothermal amplification assays) and a variety of immuno-diagnostic assays. Since it uses only microliters of sample, reagent costs are minimal and environmental impact is minimal. As it uses only microliters of sample, very little energy is required to rapidly heat the sample. The microliter sample can cool rapidly, which can significantly reduce the time for PCR cycles and significantly reduce the time required to perform a PCR assay. The small size and small energy requirements can also enable the system to be battery operated and portable. Portability, battery operation, short assay times, and prompt analysis and reporting of analysis results can enable prompt diagnosis of an illness, pathogen, or contaminant, and enable quick remedial action to be taken. The low cost can enable point of care (POC) testing where not previously practical because of the time to get test results or high testing costs. Unlike typical diagnostic assays, the system wo can be run by untrained personnel in the field to deliver actionable data in less than an hour.

While shown in a few illustrative embodiments, a person having ordinary skill in the art will recognize that the systems, apparatuses, and methods described herein are susceptible to various changes and modifications that fall within the scope of the appended claims. Moreover, descriptions of various alternatives using terms such as “or” do not require mutual exclusivity unless clearly required by the context, and the indefinite articles “a” or “an” do not limit the subject to a single instance unless clearly required by the context. Components may be also be combined or eliminated in various configurations for purposes of sale, manufacture, assembly, or use.

The claims may also encompass additional subject matter not specifically recited in detail. For example, certain features, elements, or aspects may be omitted from the claims if not necessary to distinguish the novel and inventive features from what is already known to a person having ordinary skill in the art. Features, elements, and aspects described in the context of some embodiments may also be omitted, combined, or replaced by alternative features serving the same, equivalent, or similar purpose without departing from the scope of the invention defined by the appended claims.

1. A cartridge for use in a diagnostic assay testing system, the cartridge comprising:
a pneumatic port;
a sample collection chamber;
a mixing chamber fluidly coupled to the pneumatic port;
a plurality of reagent chambers;
a plurality of reaction-chamber ports, each of the reaction-chamber ports configured to receive a reaction chamber for a specific assay; and
a valve fluidly coupled to the mixing chamber and operable to selectively couple the mixing chamber to the sample collection chamber, one of the reagent chambers, and one of the reaction-chamber ports.

2. The cartridge of claim 1, further comprising a capture chamber fluidly coupled to the mixing chamber and configured to capture magnetic micro-beads.

3. The cartridge of claim 1, further comprising a waste chamber and wherein the valve is further operable to selectively couple the mixing chamber to the waste chamber.

4. The cartridge of claim 1, wherein the valve is operable to selectively couple the mixing chamber to the sample collection chamber, one of the reagent chambers, and one of the reaction-chamber ports through one or more microchannels.

5. The cartridge of claim 1, further comprising:
a valve housing;
a valve microchannel disposed in the valve;
a cap configured to hold the valve in the valve housing; and
a cap microchannel in the cap, the cap microchannel fluidly coupled to the valve microchannel.

6. The cartridge of claim 1, wherein the valve is a rotary valve.

7. The cartridge of claim 6, wherein the rotary valve comprises a valve interface configured to be coupled to a system for running a diagnostic assay.

8. The cartridge of claim 7, wherein the valve interface comprises an axle.

9. The cartridge of claim 1, further comprising at least one reaction chamber configured for a specific assay.

10. A system for running a diagnostic assay on an assay cartridge, the system comprising:
a slot configured to receive the assay cartridge;
a detector disk configured to receive one or more detectors for the diagnostic assay;
a first motor coupled to the detector disk;
a second motor configured to be coupled to a valve interface associated with the assay cartridge;
a pneumatic pump configured to be coupled to a pneumatic port associated with the assay cartridge; and
a controller configured to:
operate the pneumatic pump to apply a negative pressure or a positive pressure to the pneumatic port,
operate the first motor to rotate the detector disk and position the detectors for the diagnostic assay,
operate the second motor to operate the valve interface for the diagnostic assay, and
analyze assay data from the detectors.

11. The system of claim 10, further comprising a communication interface configured to receive an assay protocol and configured to send assay data.

12. The system of claim 11, wherein the communication interface is a wireless communication interface.

13. The system of claim 10, wherein the detectors comprise at least one of an optical detector and a camera.

14. The system of claim 10, wherein the detectors comprise an electrochemical bioassay detector configured to be electrically coupled to the assay cartridge.

15. The system of claim 10, wherein the controller is further operable to display assay results on a display screen.

16. The system of claim 10, wherein the first motor and the second motor are the same motor.

17. The system of claim 10, further comprising:
a heater module, the heater module further comprising:
a thermal detector coupled to the controller and configured to measure a temperature of a solution in a reaction chamber in the assay cartridge; and
an LED coupled to the controller and configured to project thermal radiation onto the reaction chamber in the assay cartridge;
wherein the controller is configured to control the LED based on the temperature of the solution measured by the thermal detector.

18. A diagnostic testing system comprising:
an assay cartridge;
a system for running an assay on the assay cartridge; and
a communication interface configured to receive assay protocols and configured to send assay data.

19. The diagnostic testing system of claim 18, wherein the assay cartridge can be reconfigured to run PCR assays, immunoassays, and electrochemical bioassays.

20. The diagnostic testing system of claim 19, wherein the system for running the assay on the assay cartridge is capable of running PCR assays, immunoassays, and electrochemical bioassays.

21. (canceled)
